(19) United States
(12) Patent Application Publication
(10) Pub. No.: US 2007/0271638 A1
(43) Pub. Date: Nov. 22, 2007

(54) AUTO-TEACHING SYSTEM

(75) Inventors: Simon B. Johnson, Bonney Lake, WA (US); Lev M. Bolotin, Kirkland, WA (US); Bradley Morris Johnson, Edmonds, WA (US)

Correspondence Address: ISHIMARU & ZAHRT LLP, 333 W. EL CAMINO REAL, SUITE 330, SUNNYVALE, CA, 94087, US

(73) Assignee: Data I/O Corporation, Redmond, WA (US)

(21) Appl. No.: 11/381,532

(22) Filed: May 3, 2006

(51) Int. Cl. G06F 19/00

(52) U.S. Cl. 901/3

(57) ABSTRACT

An auto-teaching system that includes providing a first reference in a first direction. Providing a second reference in a second direction and scanning an optics system over the first reference and the second reference to determine a teach point.

### CROSS-REFERENCE TO RELATED APPLICATION(S)

The present application contains subject matter related to a concurrently filed U.S. patent application by Lev M. Bolotin entitled “AUTOMATED PROGRAMMING SYSTEM EMPLOYING NON-TEXT USER INTERFACE”. The related application is assigned to Data I/O Corporation and is identified by attorney docket number 1015-023. This application is being filed contemporaneously herewith, and the subject matter thereof is hereby incorporated herein by reference thereto.

The present application contains subject matter related to a concurrently filed U.S. patent application by Lev M. Bolotin entitled “AUTOMATED PROGRAMMING SYSTEM EMPLOYING INTELLIGENT MODULES”. The related application is assigned to Data I/O Corporation and is identified by attorney docket number 1015-024. This application is being filed contemporaneously herewith, and the subject matter thereof is hereby incorporated herein by reference thereto.

The present application contains subject matter related to a concurrently filed U.S. patent application by Lev M. Bolotin entitled “AUTOMATED PROGRAMMING SYSTEM EMPLOYING SMART INTERFACES”. The related application is assigned to Data I/O Corporation and is identified by attorney docket number 1015-025. This application is being filed contemporaneously herewith, and the subject matter thereof is hereby incorporated herein by reference thereto.

### TECHNICAL FIELD

The present invention relates generally to auto-teaching systems, and more particularly to automated programming systems employing auto-teaching systems.

### BACKGROUND ART

In general, a pick-and-place machine contains a nozzle for the purpose of picking and placing components. This nozzle is usually mounted on a moveable head, often referred to as a pick-and-place head, which allows transporting of components between different locations within the working envelope of a robot. The location of the nozzle is known at all times via the use of encoders, which track the nozzle location through a two dimensional coordinate system (i.e.—X and Y). In order for components to be picked and placed accurately within the working envelope of the pick-and-place machine, the destinations have to be known absolutely. Presently, most systems learn exact destinations by having an operator manually teach the module picking positions and placing positions.

The reference point for any encoder is the home position. The home position is determined by moving any axis in the direction of the home flag, until a home detection sensor is activated. This process provides a reference point for all head movements. Although the home position provides a reference point, it is only a reference point relative to other positions.

While the home position can be detected quite accurately, module locations, such as input/output module cavities and programming module cavities, within the robot working envelope are known to an approximate value. Consequently, the locations of these module cavities are not known accurately enough for pick-and-place operations.

Presently, most pick-and-place operations require manual teaching of the exact location of a module cavity by an operator. This is an extremely time consuming process that requires the following steps: home location, approximate cavity location, exact component location, and coordinate storage. First, an operator must locate the home coordinate system by aligning the robot with the home detection sensors for each coordinate axis (i.e.—X and Y). Next, the operator repositions the robot to the approximate location of the module cavity. Then, with the nozzle in the down position, the operator mainly “jogs” the pick-and-place head until the nozzle meets a reference feature, such as a component or center of cavity.

Once a visual check by the operator has ascertained that the nozzle is positioned at the correct destination, the operator instructs the robot to remember the current coordinates (encoders values). This procedure is repeated until all the reference features have been determined by the coordinate system. Not only is this process costly and time consuming but also it is fraught with human error, such as unsophisticated operator visual identification steps. Additionally, with automated programming systems, where the modules need to be exchanged quite often, productivity is severally curtailed due to time spent on additional machine setup steps and operator learning curve.

The pick-and-place industry does employ some automated teaching operations but they are normally based upon vision systems that are installed on the robotics arm or on the frame of the machine. Usually these vision systems are capable of delivering the accuracy required to determine the coordinates of each reference feature, but they are very sensitive to the quality and consistency of light provided. Consequently, they are very expensive. Additionally, in many areas of the world, it is very difficult to provide the necessary consistency in the electrical power source to produce the required quality light source.

Thus, a need still remains for a reliable and robust pick-and-place machine, which employs an auto-teaching mechanism. In view of the ever-increasing need to save costs and improve efficiencies, it is more and more critical that answers be found to these problems.

Solutions to these problems have been long sought but prior developments have not taught or suggested any solutions and, thus, solutions to these problems have long eluded those skilled in the art.

### DISCLOSURE OF THE INVENTION

The present invention provides an auto-teaching system, which includes providing a first reference in a first direction 302. Providing a second reference in a second direction 304 and scanning an optics system over the first reference and the second reference to determine a teach point.

Certain embodiments of the invention have other aspects in addition to or in place of those mentioned above. The aspects will become apparent to those skilled in the art from a reading of the following detailed description when taken with reference to the accompanying drawings.

### BRIEF DESCRIPTION OF THE DRAWINGS

FIG. 1 is an isometric view of an automated programming system in accordance with an embodiment of the present invention;

FIG. 2 is an isometric view of an automated programming system with part of a cover removed in accordance with an embodiment of the present invention;

FIG. 3 is a top view of teaching targets used to locate a teach point in accordance with an embodiment of the present invention;

FIG. 4 is a sequence of optic movements that define a teach point in accordance with an embodiment of the present invention;

FIG. 5 is a sequence of optic movements that define a teach point in accordance with another embodiment of the present invention;

FIG. 6 is an illustration of the perceived location of a teaching target point in accordance with an embodiment of the present invention;

FIG. 7 is an overview of an auto-teach system in accordance with an embodiment of the present invention;

FIG. 8 is a flow chart for an automated programming system for fabricating the automated programming system in accordance with an embodiment of the present invention.

### BEST MODE FOR CARRYING OUT THE INVENTION

The following embodiments are described in sufficient detail to enable those skilled in the art to make and use the invention, and it is to be understood that other embodiments would be evident based on the present disclosure and that process or mechanical changes may be made without departing from the scope of the present invention.

In the following description, numerous specific details are given to provide a thorough understanding of the invention. However, it will be apparent that the invention may be practiced without these specific details. In order to avoid obscuring the present invention, some well-known system configurations, and process steps are not disclosed in detail. Likewise, the drawings showing embodiments of the invention are semi-diagrammatic and not to scale and, particularly, some of the dimensions are for the clarity of presentation and are shown exaggerated in the drawing FIGs. In addition, where multiple embodiments are disclosed and described having some features in common, for clarity and ease of illustration, description, and comprehension thereof, similar and like features one to another will ordinarily be described with like reference numerals.

The term “horizontal” as used herein is defined as a plane parallel to the plane or surface of the top of an automated programming system, regardless of its orientation. The term “vertical” refers to a direction perpendicular to the horizontal as just defined. Terms, such as “on”, “above”, “below”, “bottom”, “top”, “side” (as in “sidewall”), “higher”, “lower”, “upper”, “over”, and “under”, are defined with respect to the horizontal plane.

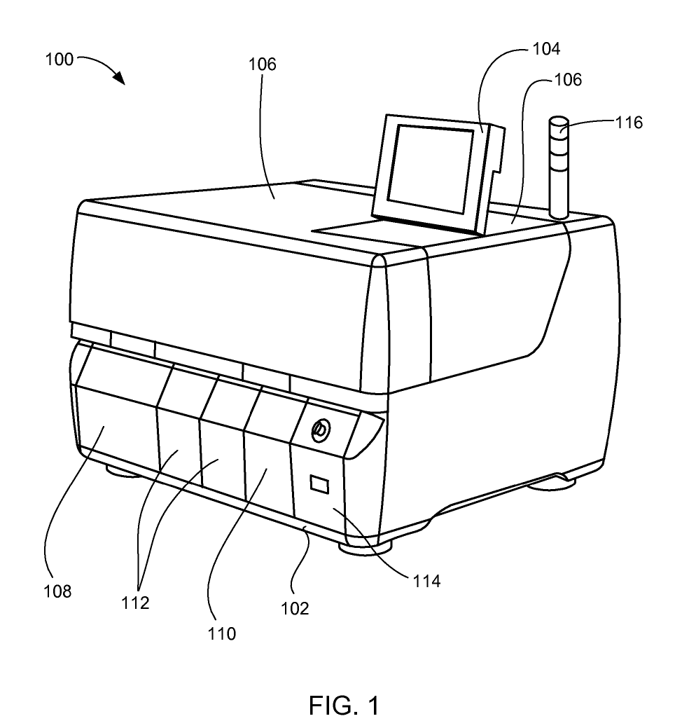

Referring now to FIG. 1, therein is shown an isometric view of an automated programming system 100 in accordance with an embodiment of the present invention. The automated programming system 100 includes a frame 102, a monitor 104, a cover 106, an input module 108, an output module 110, programming modules 112, control electronics 114, and a status indicator 116. As an exemplary illustration, the automated programming system 100 may include a desktop handler system with a pick-and-place mechanism. The desktop handler system is a portable programming system. To enhance portability of the desktop handler system, handles may be built-in.

The frame 102 is the main housing that holds all the elements together and provides structural support. The monitor 104 can be mounted to a fixed portion of the cover 106. By way of example and not by way of limitation, the monitor 104 may include a touch screen user interface system that provides visual feedback to the operator.

The cover 106 is mounted to the frame 102 and covers the working envelope of the machine. The cover 106 offers protection to the input module 108, the output module 110, and the programming modules 112 from dust and debris within the working environment. Additionally, the cover 106 protects an operator from unintended operational hazards.

Devices and/or media enter and exit the automated programming system 100 via removable modules, such as the input module 108 or the output module 110. Alternatively, the devices and/or media can be placed within or removed from the automated programming system 100 without removing the input module 108 and the output module 110 from the automated programming system 100. By way of example, the input module 108 and the output module 110 may be configured to accommodate trays or other receptacles, which conform to Joint Electron Device Engineering Council (JEDEC) standards. However, it is to be understood that the present invention is not to be limited to such configurations. In accordance with the present invention the input module 108 and the output module 110 may accommodate any device receptacle.

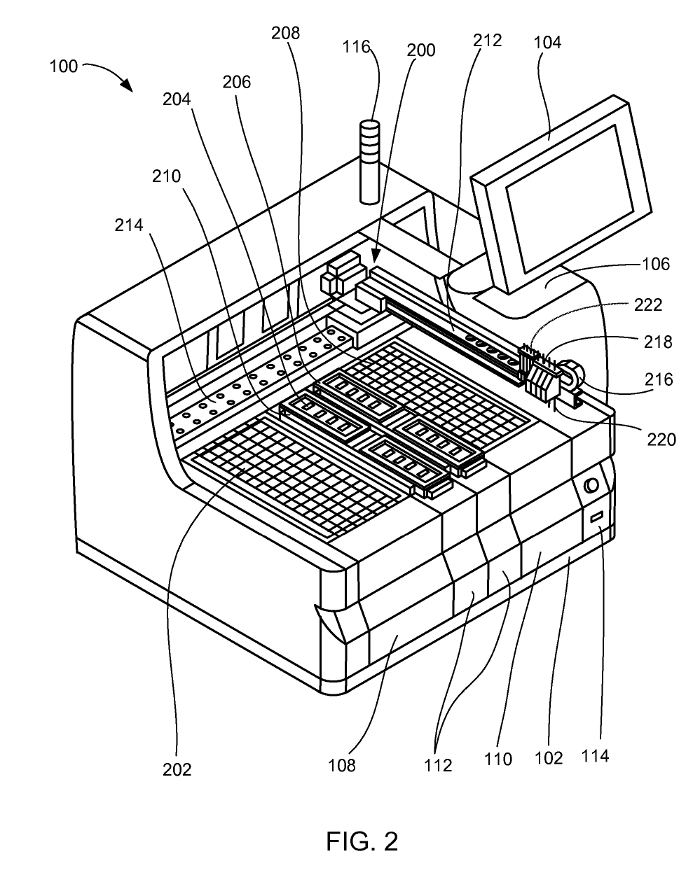

The programming modules 112 provide the core processing interface for the automated programming system 100. The programming modules 112 include one or more removable modules that interface with the automated programming system 100. Each of the programming modules 112 may also be configured to accommodate receptacles, which conform to JEDEC standards. These receptacles may contain socket adapters (described in greater detail in FIG. 2), an actuator(s) (described in greater detail in FIG. 2) and a reject bin (described in greater detail in FIG. 2), for receiving devices. After the devices, such as unprogrammed programmable media, are placed within the socket adapters, the actuators close the sockets so that the devices are appropriately connected to the programming modules 112 of the automated programming system 100. Additionally, the programming modules 112 can be controlled by the automated programming system 100 for facilitating configuration setup and manual operations, such as placing and removing programmable media.

Additionally, by way of example, each of the modules within the automated programming system 100 may include a module control system, which allows each module to be set-up for purposes of programming, configuration, and identification. Alternatively, instead of placing the module control system as part of each module, the module control system and its function can be integrated as part of the touch screen user interface system displayed by the monitor 104.

The control electronics 114 are also mounted on the frame 102. The control electronics 114 provide an electrical interface for the automated programming system 100. For example, the control electronics 114 may possess a power ON/OFF switch and/or digital input/output boards, which are connected to external sensors. Notably, the automated programming system 100 does not rely on an external vacuum system, which greatly enhances the portability of the machine. The automated programming system 100 possesses an on-board vacuum system that is powered by electrical current, therefore, the automated programming system 100 is a self-sufficient system that only requires an electrical power for operation. Additionally, the back of the automated programming system 100 may possess additional power modules.

The status indicator 116 is also mounted on the frame 102. The status indicator 116 provides visual feedback, via a non-text error signal, to the user about machine status. As an exemplary illustration, the status indicator 116 may use a multi-color scheme employing more than one light combination. The particular combination can be done in such a way that a green light indicates the machine is in operation, a yellow light indicates that attention may be needed soon and a red light indicates there may be a problem, and the machine is stopped, or that the job has terminated normally. However, it is to be understood that any color scheme may be used to convey the notions of operation-ready, attention may be needed soon, and operation-termination.

Referring now to FIG. 2, therein is shown an isometric view of the automated programming system 100 with part of the cover 106 removed in accordance with an embodiment of the present invention. The automated programming system 100 includes a frame 102, a monitor 104, an input module 108, an output module 110, programming modules 112, control electronics 114, a status indicator 116, a robotics system 200, an input device receptacle 202, socket adapters 204, actuators 206, an output device receptacle 208, a reject bin 210, a gantry 212, a track 214, an arm 216, a head system 218, nozzles 220, and an optics system 222.

The robotics system 200, and more generally the automated programming system 100, can be controlled by a user interface system, such as a graphical non-text user interface system. In accordance with the scope of the present invention, a non-text user interface system uses only numbers and symbols to communicate information to an operator and not written words. The user interface system can provide feedback to an operator via visual or auditory stimulus.

The user interface system, displayed by the monitor 104, provides a real time image of the working envelope (i.e.—the system configuration). The working envelope includes the input module 108, the output module 110, the programming modules 112, the input device receptacle 202, the socket adapters 204, the actuators 206, the output device receptacle 208, and the reject bin 210. Although not shown, the present invention may include an additional module, such as a marking module, which possesses the ability to mark a device as to its programming status. For example, a device that has been processed successfully may be marked with a green dot to differentiate good parts from bad or unprogrammed. By modeling the real time representation of the working envelope, the monitor 104 helps to eliminate operator mistakes during set up of the automated programming system 100. Additionally, the real time image on the monitor 104 can increase operator productivity due to its accurate representation of the working envelope.

Not only does the user interface system display a real time image of the working envelope, but it may also provide programming setup and status information. In general, the user interface system of the present invention includes the following categories to control a programming system: job selection, programming, device and hardware detection, and statistical job feedback. These categories are controlled via a plethora of functions, such as job status inquires, job control, job tools, socket use, job selection, receptacle map, and measure receptacle. These functions provide a workable user interface for the automated programming system 100 that do not require textual representation, and therefore allow global application of the user interface.

Additionally, the user interface system can be configured for remote operation, as well as, remote diagnostics access.

During operation, the robotics system 200, which includes a pick-and-place system, retrieves one or more devices (not shown) from the input device receptacle 202, located over the input module 108. The robotics system 200 then transports the device(s) to the programming modules 112 which possess the socket adapters 204 and the actuators 206. Once the socket adapters 204 engage the devices, programming may commence. Once programming is complete, the robotics system 200 then transports the good devices to the output device receptacle 208, located over the output module 110, and transports the bad devices to the reject bin 210.

The robotics system 200 is attached to an L-shaped base, which is part of the frame 102. The L-shaped base provides a rigid, lightweight, cast, platform for the robotics system 200. Additionally, the L-shaped base allows easy access to the working envelope of the automated programming system 100. The L-shaped base may contain a smart interface system for interfacing with intelligent modules.

The robotics system 200 includes a gantry 212, a track 214, an arm 216, a head system 218, nozzles 220, and an optics system 222. The gantry 212 supports the arm 216, the head system 218, the nozzles 220 and the optics system 222. The gantry 212 slides back and forth (i.e.—in the X direction) across the track 214. The head system 218, the nozzles 220, and the optics system 222 slide back and forth (i.e.—in the Y direction) across the arm 216 supported by the gantry 212. The head system 218 may additionally move up and down (i.e.—in the Z direction) and rotate (i.e.—in the theta direction).

The head system 218, may include by way of example and not by way of limitation, a pick-and-place head system, which can employ multiple design configurations, such as a multi-probe design. The head system 218 is a small sized, lightweight system to facilitate fast and accurate movements, such as in the vertical direction. Imprecise movements of the head system 218 are accommodated for by a built-in compliance mechanism. The built-in compliance mechanism can be based upon mechanical principles, such as a spring, or upon electrical principles, for example.

In further attempts to reduce the size and weight of the head system 218, particular aspects of the invention employ limited theta or rotational movement for each up and down or Z position.

The head system 218 may be powered by an electrical stimulus, a pneumatic stimulus or any stimulus that produces the desired result of moving the head system 218. Uniquely, the nozzles 220 of the head system 218 do not rely on an external air supply. If pneumatics are used to operate the nozzles 220, they are provided via an on-board vacuum system. Therefore, the automated programming system 100 can be designed to only require electrical power for operation. By not requiring each potential operations facility to possess a clean and special external air supply, the automated programming system 100 becomes universally portable and employable.

Furthermore, adjacent to the head system 218 is an optics system 222 that is displaceable due to its attachment to the head system 218. The optics system 222 enables the robotics system 200 to automatically map the physical characteristics of modules. As exemplary illustrations, modules may include the input module 108, the output module 110, the programming modules 112, and the reject bin 210. More specifically, the optics system 222 can automatically measure the physical characteristics and geometry of a receptacle placed over a module. For each receptacle, the optics system 222 can automatically map out the number of rows, the number of columns, the row offset, the row pitch, the column offset and the column pitch. Additionally, the optics system 222 can also map the socket adapters 204 and the actuators 206 of the programming modules 112.

These automatic measurements will provide information about the exact coordinates (i.e.—X, Y, Z and/or theta directions) for each feature within the working envelope of the robotics system 200. The present invention may employ a one, two, three, or four dimensional coordinate system. Additionally, by way of example and not by way of limitation, a feature may include the center of a cavity, the center of a socket adapter, and/or the center of a component, such as a device or media. Furthermore, a receptacle may include an M×N array of features, wherein M and N are positive integers.

The optics system 222 employs optical methods based upon changes in state, such as reflectivity, and specifically designed algorithms to calculate the exact coordinates for each feature. This system is designed in such a way that the operator no longer has to manually determine the exact coordinates of each feature, which saves the operator time and prevents operator input error.

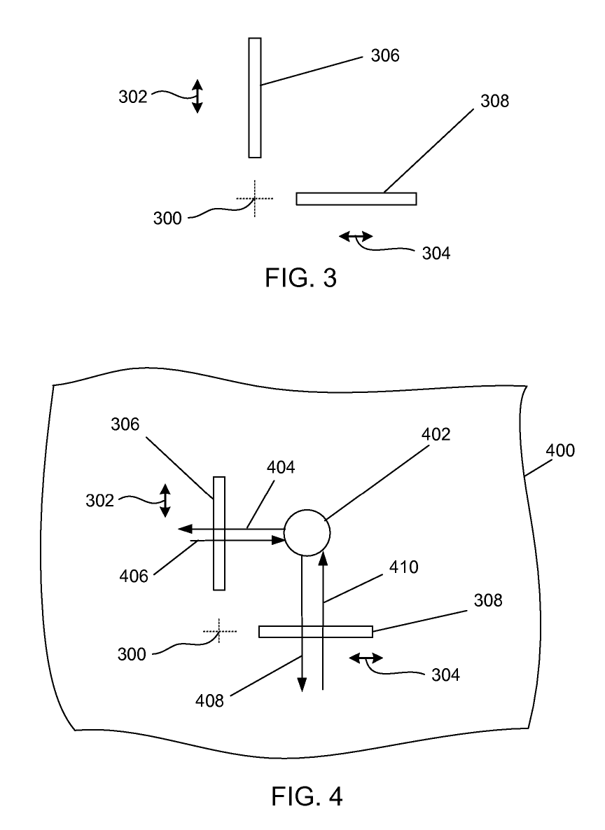

Referring now to FIG. 3, therein is shown a top view of teaching targets used to locate a teach point 300 in accordance with an embodiment of the present invention. The teach point 300 is the common point of reference for all other locations within a module's coordinate system. In other words, all locations within the coordinate system are defined with respect to the teach point 300. As an exemplary illustration, the teach point 300 could be a socket adapter or the corner of a receptacle, such as the top left corner. However, it is to be understood that the present invention is not to be limited to these examples. In accordance with the scope of the invention, the teach point 300 may include any common point of reference that is accessible to all locations within the coordinate system.

Per this embodiment, the teach point 300 is defined by teaching targets formed in a first direction 302 and in a second direction 304, wherein the first direction 302 and the second direction 304 are in different directions, such as orthogonal to each other. For example, the teaching targets may include a first reference 306, formed in the first direction 302, and a second reference 308 formed in the second direction 304. The teaching targets can be easily created by placing a non-reflective marking against a reflective surface or vice-versa. In this particular embodiment, the first reference 306 and the second reference 308 are non-reflective markings placed against a reflective background.

Once the teach point 300 is determined, features, such as cavities, socket adapters and components, can be mapped out (i.e.—their X, Y, Z, and theta locations determined) with respect to the teach point 300. A feature location can be determined as an offset from the teaching point 300. For example, an installed module may communicate to the automated programming system 100, of FIG. 1, that socket #1 is located 36.50 mm in the X direction and 22.60 mm in the Y direction from their respective teaching targets. Once the absolute location of the teaching point 300 is found (Xa, Ya), the absolute location for socket #1 is defined as (Xa+36.50, Ya+22.60). Generally, the teach point 300 provides the basis for a relative coordinate system for features within the working envelope. The process for determining the teach point 300 will be described further in FIG. 4

Referring now to FIG. 4, therein is shown a sequence of optic movements that define the teach point 300 in accordance with an embodiment of the present invention. Generally, this sequence of optics movements performs an auto-teaching method for determining locations, such as module locations, within a pick-and-place system. More specifically, this auto-teaching method determines the teach point 300, which is used as a reference point in determination of other feature locations within the pick-and-place system.

The first reference 306 and the second reference 308 are non-reflective markings placed over a substrate 400, such as a reflective module. The first reference 306 and the second reference 308 could just as easily be reflective markings placed over a non-reflective substrate. The first reference 306 can be formed in the first direction 302 and the second reference 308 can be formed in the second direction 304, wherein the first direction 302 and the second direction 304 are in different directions. For example, the first direction 302 and the second direction 304 may be orthogonal to each other.

Circle 402 can represent the starting location of the optics system 222, of FIG. 2. A first scan direction 404, a second scan direction 406, a third scan direction 408, and a fourth scan direction 410 denote the direction of displacement of the optics system 222 during its auto-teach operation.

As an exemplary illustration, the optics system 222 may begin its scanning movement from above the substrate 400, and more specifically, from above the circle 402. However, it is to be understood that the optics system 222 can begin scanning from any location that will intersect the first reference 306 and the second reference 308. For example, horizontal scanning can begin from any location that will intersect a vertical line and vertical scanning may begin from any location that will intersect a horizontal line.

Initially, the optics system 222 can move in the direction of the first scan direction 404, which is perpendicular to the first reference 306. As the optics system 222 passes over a leading edge of the first reference 306 (which is non-reflective), sensors, which are located in the optics system 222, perceive and record the change in reflectivity. As the optics system 222 continues along the route of the first scan direction 404, it passes over a trailing edge of the first reference 306, the sensors once again perceive and record the changes in reflectivity.

After traveling a sufficient distance past the first reference 306 in the path of the first scan direction 404, to ensure that the optics system 222 is over the substrate 400, it then stops and begins moving in an opposite direction back over the first reference 306. The optics system 222 is now traveling in the direction of the second scan direction 406, which is also perpendicular to the first reference 306. As the optics system 222 travels along this path, it perceives and records the change in reflectivity as it passes over the first reference 306. The optics system 222 stops once it has returned to its starting location, the circle 402.

This sequence of scans has defined the location of the first reference 306. Now, the location of the second reference 308 must be defined. Beginning from the circle 402, the optics system 222 can move in the direction of the third scan direction 408, which is perpendicular to the second reference 308. As the optics system 222 passes over a leading edge of the second reference 308 (which is non-reflective), the sensors perceive and record the change in reflectivity. As the optics system 222 continues along the route of the third scan direction 408, it passes over a trailing edge of the second reference 308, the sensors once again perceive and record the changes in reflectivity.

After traveling a sufficient distance past the second reference 308 in the path of the third scan direction 408, to ensure that the optics system 222 is over the substrate 400, it then stops and begins moving in an opposite direction back over the second reference 308. The optics system 222 is now traveling in the direction of the fourth scan direction 410, which is also perpendicular to the second reference 308. As the optics system 222 travels along this path, it perceives and records the change in reflectivity as it passes over the second reference 308. The optics system 222 stops once it has returned to its starting location, circle 402. This sequence of scans has defined the location of the second reference 308.

The optics system 222 employs a mechanism for measuring the change in reflectivity as the optics system 222 passes over a non-reflective marking from or to a reflective surface. When the optics system 222 registers the change in reflectivity, a motor controller receives a value from an encoder, which determines the coordinate for the axis in question. There is a slight delay between when the optics system 222 registers the change in reflectivity and when the monitoring micro-controller reads the encoder coordinate, this is due to the time that it takes the monitoring electronics to respond. Consequently, this delay introduces a slight shift in the perceived location of both the first reference 306 and the second reference 308. FIG. 6 describes in greater detail the slight shift in perceived locations of teaching targets and the method employed to correct such shifts.

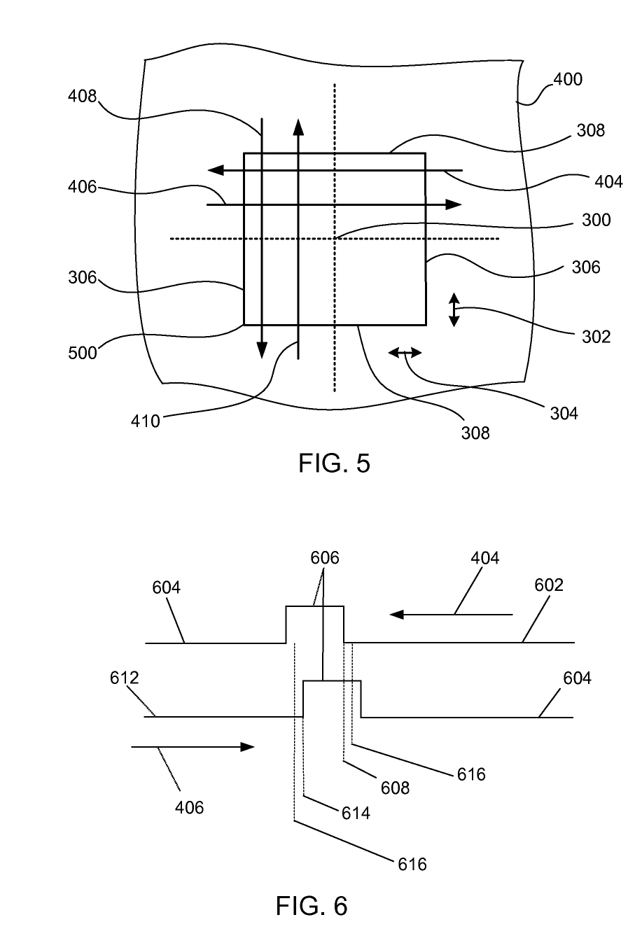

Referring now to FIG. 5. FIG. 5 depicts a similar configuration as to that shown in FIG. 4, and consequently, only the differences between the figures will be described, to avoid redundancy.

FIG. 5 shows a sequence of optic movements that define the teach point 300 in accordance with another embodiment of the present invention. Per this embodiment, an object 500 acts as the reference mark. For example, the object 500 may include a receptacle within the automated programming system 100, of FIGS. 1 and 2. The object 500 may be placed over a substrate 400, such as the input module 108, of FIGS. 1 and 2, for example. As with the previous embodiment, the object 500 may be reflective and the substrate 400 may be non-reflective or vice-versa.

Unlike the previous embodiment, the first reference 306 and the second reference 308 are no longer markings placed over a substrate 400. Per this embodiment, the first reference 306 and the second reference 308 are now part of the object 500. For example, the first reference 306 can correspond to opposing sides of the object 500 and the second reference 308 can correspond to a different set of opposing sides of the object 500. According to this example, the first reference 306 is formed in the first direction 302 and the second reference 308 is formed in the second direction 304, wherein the first direction 302 and the second direction 304 are in different directions.

As with the previous embodiment, the first scan direction 404 and the second scan direction 406 scan over the first reference 306 and the third scan direction 408 and the fourth scan direction 410 scan over the second reference 308. After scanning the teach point 300 can be computed.

Although the present embodiment depicts the object 500 formed as a square, it is to be understood that the object 500 may take any shape. For example, if the object 500 were round or oblong, the sequence of optic movements described above could still determine the teach point 300 of the object 500.

Referring now to FIG. 6, therein is shown an illustration of the perceived location of a teaching target point in accordance with an embodiment of the present invention. The optics system 222, as shown in FIG. 2, measures a change in reflectivity as it passes over a teaching target, such as the first reference 306, as shown in FIGS. 4 and 5, or the second reference 308, as shown in FIGS. 4 and 5. Due to the slight delay between when a motor controller registers the change in reflectivity from the optics system 222 and when the motor controller reads the encoder coordinate, there is slight shift in the value assigned. This shift in the value assigned is compensated for by the following method.

This embodiment depicts the first scan direction 404, a first scan perceived location line 602, a reflective surface 604, a non-reflective surface 606, a perceived leading edge of the first scan direction 608, the second scan direction 406, a second scan perceived location line 612, a perceived leading edge of the second scan direction 614 and a real teaching target 616. The first scan perceived location line 602 travels along the first scan direction 404. The first scan perceived location line 602 initially travels over the reflective surface 604 and then travels over the non-reflective surface 606. The perceived leading edge of the first scan direction 608 marks the perceived change in reflectivity by the motor controller.

The second scan perceived location line 612 travels along the second scan direction 406, which is opposite to the first scan direction 404. The second scan perceived location line 612 initially travels over the reflective surface 604 and then travels over the non-reflective surface 606. The perceived leading edge of the second scan direction 614 marks the perceived change in reflectivity by the motor controller.

This embodiment illustrates how the perceived leading edge of the first scan direction 608 and the perceived leading edge of the second scan direction 614 are shifted from the true location of the real teaching target 616. Additionally, it can be seen that the mid-point of the first scan perceived location line 602 and the second scan perceived location line 612 will yield an erroneous mid-point value for the real teaching target 616. However, an accurate mid-point of the real teaching target can be determined by the following formula:
Mid-point=(X1+X2)/2

Mid-point can be defined generally as the center of the real teaching target 616, X1 can be the motor controller value assigned to the perceived leading edge of the first scan direction 608, and X2 can be the motor controller value assigned to the perceived leading edge of the second scan direction 614. The above formula can be applied to determine the mid-point of all teaching targets, such as the first reference 306 and the second reference 308. By computing the mid-point of the first reference 306 and second reference 308, the intersection (i.e.—the teach point 300—of FIGS. 3, 4 and 5) of the first reference 306 and second reference 308 can be determined.

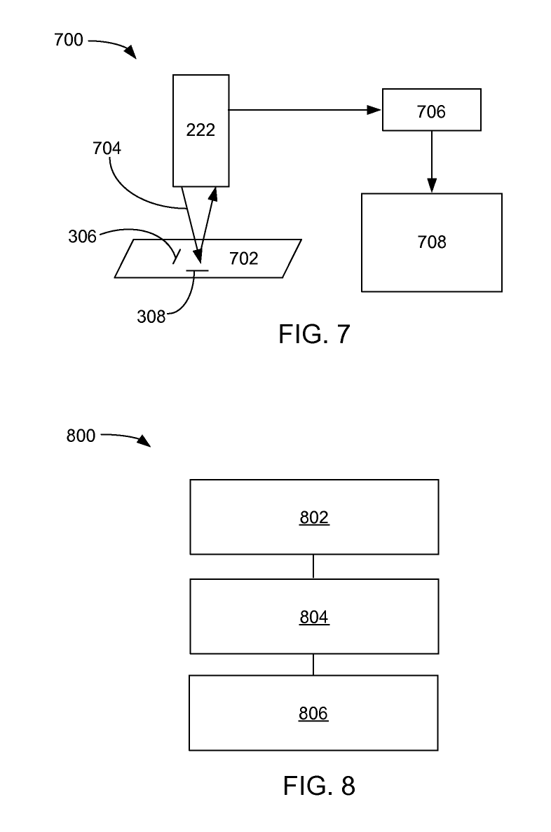

Referring now to FIG. 7, therein is shown an overview of an auto-teaching system 700 in accordance with an embodiment of the present invention. The auto-teaching system 700 includes the optics system 222, the first reference 306, the second reference 308, a receptacle 702, an optic path 704, a motor encoder/controller 706, and a processing unit 708. The optics system 222 scans back and forth across the receptacle 702, which may include a reflective surface. Although the first reference 306 and the second reference 308 are shown as separate reference markings, they may also be part of the object 500, as shown in FIG. 5.

As the optics system 222 scans the receptacle 702, the optic path 704 can be interrupted by the first reference 306 or the second reference 308. This interruption in the optic path 704 registers as a change in reflectivity through a sensor within the optics system 222. A signal representing the change in reflectivity is then sent to the motor encoder/controller 706. The motor encoder/controller 706 assigns a coordinate position to this signal. The motor encoder/controller 706 then sends the coordinate position to the processing unit 708. The processing unit 708 stores the information for later manipulation, such as determination of the teach point 300, of FIGS. 3, 4 and 5, location and/or receptacle mapping.

In accordance with an aspect of the present invention, the shift associated with the perceived location of the teaching targets is minimized by tightly coupling the optic system 222 with the motor encoder/controller 706.

Referring now to FIG. 8, therein is shown a flow chart for an auto-teaching system 800 for employing the auto-teaching system 700 in accordance with an embodiment of the present invention. The auto-teaching system 800 includes providing a first reference in a first direction in a block 802; providing a second reference in a second direction in a block 804; and scanning an optics system over the first reference and the second reference to determine a teach point in a block 806

From the above it will be understood that the present invention is applicable to what can be described as “devices” or “media”. Devices and/or media include a broad range of electronic and mechanical devices. The best mode describes programming of devices and/or media, which include, but are not limited to, Flash memories (Flash), electrically erasable programmable read only memories (EEPROM), programmable logic devices (PLDs), field programmable gate arrays (FPGAs), and microcontrollers. However, the present invention encompasses programming for all electronic, mechanical, hybrid, and other devices or media, which require testing, measurement of device characteristics, calibration, and other programming operations. For example, these types of devices and/or media would include, but not be limited to, microprocessors, integrated circuits (ICs), application specific integrated circuits (ASICs), micro mechanical machines, micro-electro-mechanical (MEMs) devices, micro modules, and fluidic systems.

It has been discovered that the present invention thus has numerous aspects. A principle aspect is the elimination of current manual teaching techniques for the determination of a home position. The present invention employs an auto-teach system that can automatically determine the home position/teach point, which helps to eliminate operator error.

Another aspect of the present invention is the ability to correctly calculate the midpoint position of a reference by accounting for shift errors due to signal delay.

These and other valuable aspects of the present invention consequently further the state of the technology to at least the next level.

Thus, it has been discovered that the auto-teaching system of the present invention furnishes important and heretofore unknown and unavailable solutions, capabilities, and functional aspects. For instance, the present invention employs an auto-teach system that automatically and accurately determines the location of a home position/teach point, thereby, reducing operator error. The resulting processes and configurations are straightforward, cost-effective, uncomplicated, highly versatile and effective, can be implemented by adapting known technologies, and are thus readily suited for efficient and economical manufacturing.

While the invention has been described in conjunction with a specific best mode, it is to be understood that many alternatives, modifications, and variations will be apparent to those skilled in the art in light of the aforegoing description. Accordingly, it is intended to embrace all such alternatives, modifications, and variations, which fall within the scope of the included claims. All matters hithertofore set forth herein or shown in the accompanying drawings are to be interpreted in an illustrative and non-limiting sense.

The invention claimed is:

1. An auto-teaching system comprising:
providing a first reference in a first direction;
providing a second reference in a second direction; and
scanning an optics system over the first reference and the second reference to determine a teach point.

2. The system as claimed in claim 1 wherein:
scanning the optics system includes determining any common point of reference that is accessible to all locations within a coordinate system as the teach point.

3. The system as claimed in claim 1 wherein:
scanning the optics system includes perceiving and recording changes in reflectivity of the first reference.

4. The system as claimed in claim 3 wherein:
scanning the optics system includes perceiving and recording changes in reflectivity of the second reference.

5. The system as claimed in claim 4 wherein:
scanning the optics system to determine the teach point also includes accounting for a slight shift in perceived location.

6. An auto-teaching system comprising:
providing a first reference in a first direction;
providing a second reference in a second direction;
displacing an optics system in a first scan direction over the first reference;
displacing the optics system in a second scan direction over the first reference;
displacing the optics system in a third scan direction over the second reference;
displacing the optics system in a fourth scan direction over the second reference; and
computing the mid-point of the first reference and the second reference to determine a teach point.

7. The system as claimed in claim 6 wherein:
displacing the optics system in the first scan direction and in the second scan direction includes displacement orthogonal to the first reference.

8. The system as claimed in claim 6 wherein:
displacing the optics system in the third scan direction and in the fourth scan direction includes displacement orthogonal to the second reference.

9. The system as claimed in claim 6 further comprising:
locating the teach point at a socket, a cavity, or a corner of a receptacle.

10. The system as claimed in claim 6 wherein:
computing the mid-point of the first reference and the second reference compensates for a slight shift in the perceived location of both the first reference and the second reference.

11. An auto-teaching system comprising:
a first reference in a first direction for defining a teach point;
a second reference in a second direction for defining the teach point; and
an optics system for scanning over the first reference and the second reference to determine the teach point.

12. The system as claimed in claim 11 wherein:
the teach point includes any common point of reference that is accessible to all locations within a coordinate system.

13. The system as claimed in claim 11 wherein:
the optics system determines the teach point by changes in reflectivity of the first reference and the second reference.

14. The system as claimed in claim 11 wherein:
the first reference and the second reference are non-reflective markings.

15. The system as claimed in claim 11 wherein:
the teach point is determined by accounting for a slight shift in perceived location.

16. The system as claimed in claim 11 wherein:
the teach point is used to locate a socket, a cavity, or a corner of a receptacle.

17. The system as claimed in claim 11 wherein:
the teach point provides a relative coordinate system for features within a working envelope.

18. The system as claimed in claim 11 wherein:
the optics system measures physical characteristics and geometry of a receptacle.

19. The system as claimed in claim 11 further comprising:
a robotics system for pick-and-place operations.

20. The system as claimed in claim 11 further comprising:
a motor encoder/controller for assigning coordinate positions to the first reference and the second reference.
